(19) United States
(12) Patent Application Publication
(10) Pub. No.: US 2023/0229902 A1
(43) Pub. Date: Jul. 20, 2023

(54) KEY-BASED COMPARISON IN NEURAL ENGINE CIRCUIT

(71) Applicant: Apple Inc., Cupertino, CA (US)

(72) Inventor: Christopher L. Mills, Saratoga, CA (US)

(21) Appl. No.: 17/579,477

(22) Filed: Jan. 19, 2022

(51) Int. Cl. G06N 3/063; G06F 7/06

(52) U.S. Cl. CPC G06N 3/0635; G06F 7/06

(57) ABSTRACT

Embodiments relate to a neural engine circuit of a neural network processor circuit that performs a parallel sorting operation on input data. The neural engine circuit includes operation circuits and an accumulator circuit coupled to the outputs of the operation circuits. Each of the operation circuits operates in parallel and is configured to compare a field of a first record of a first set of records and a corresponding field of a second record of a second set of records to generate a comparison result on values in the field and the corresponding field. The accumulator circuit includes a record store storing records that are involved in the parallel sorting operation and a sideband register that stores the comparison results generated by the operation circuits.

### BACKGROUND

### 1. Field of the Disclosure

The present disclosure relates a circuit for performing operations related to neural networks, and more specifically to a neural engine circuit that performs comparisons and swapping operations to sort records of data.

### 2. Description of the Related Arts

An artificial neural network (ANN) is a computing system or model that uses a collection of connected nodes to process input data. The ANN is typically organized into layers where different layers perform different types of transformation on their input. Extensions or variants of ANN such as convolution neural network (CNN), recurrent neural networks (RNN) and deep belief networks (DBN) have come to receive much attention. These computing systems or models often involve extensive computing operations, including sorting data that may have various fields of data maintained in a single structure throughout the sorting operations.

Depending on the types of input data and operations to be performed, these machine learning systems or models can be configured differently. Such varying configuration would include, for example, pre-processing operations, the number of channels in input data, kernel data to be used, non-linear function to be applied to convolution result, and applying of various post-processing operations. Using a central processing unit (CPU) and its main memory to instantiate and execute machine learning systems or models of various configuration is relatively easy because such systems or models can be instantiated with mere updates to code. However, relying solely on the CPU for various operations of these machine learning systems or models would consume significant bandwidth of a central processing unit as well as increase the overall power consumption.

### SUMMARY

Embodiments relate to a neural engine circuit of a neural network processor circuit that performs a parallel sorting operation on input data to compare fields first records and corresponding fields of second records. The neural engine circuit includes operation circuits and an accumulator circuit coupled to the outputs of the operation circuits. Each of the operation circuits operates in parallel and is configured to compare a field of a first record of a first set of records and a corresponding field of a second record of a second set of records to generate a comparison result on values in the field and the corresponding field. The accumulator circuit includes a record store storing records undergoing the parallel sorting operation and a sideband register that stores the comparison results.

In one or more embodiments, the accumulator circuit further includes a key mask register storing indices indicating key fields and non-key fields for generating masked comparison results.

In one or more embodiments, the neural engine circuit further includes a masking circuit coupled to the accumulator circuit. The masking circuit masks the comparison result by setting the values of the comparison result at the non-key fields to a modified value indicating the values of the first and second records at the non-key field indices are equal.

In one or more embodiments, the neural engine circuit further includes a priority encoder coupled, via the masking circuit, to the accumulator circuit. The priority encoder traverses each of the masked comparison results at key fields indicated by a key mask register. The priority encoder transmits, during a read operation, the records to a post-processor in a sequence determined using the traversed comparison results.

In one or more embodiments, the priority encoder determines a highest non-zero value of each of masked comparison results and determines the sequence using the highest non-zero values.

In one or more embodiments, during a resident mode of operation, the records are stored at a data processor circuit coupled to the neural engine circuit and during a non-resident mode of operation, the records are stored at a system memory coupled to the neural engine circuit through at least the data processor circuit (e.g., the system memory sends the records to circuits, including the data processor circuit, and the data processor circuit then sends the records to the neural engine circuit).

In one or more embodiments, the comparison result is indicative of a lexicographical comparison.

In one or more embodiments, the first set of records is received during a first operation cycle and the second set of records is received during a second operation cycle subsequent to the first operation cycle.

In one or more embodiments, each of the operation circuits includes a multiplier circuit, an adder circuit, and a comparator circuit. The comparator circuit determines the comparison result. The comparator circuit is coupled to the accumulator circuit.

### BRIEF DESCRIPTION OF THE DRAWINGS

FIG. 1 is a high-level diagram of an electronic device, according to one embodiment.

FIG. 2 is a block diagram illustrating components in the electronic device, according to one embodiment.

FIG. 3 is a block diagram illustrating a neural processor circuit, according to one embodiment.

FIG. 4A is a block diagram of neural engine, according to one embodiment.

FIG. 4B is a block diagram of neural engine illustrating operations in a second mode, according to one embodiment.

FIG. 5A shows a circuit diagram in a first of two operational cycles, according to one embodiment.

FIG. 5B shows a circuit diagram in a second of two operational cycles, according to one embodiment.

FIG. 6 is a flowchart illustrating a process of key-based sorting using a neural engine circuit, according to one embodiment.

FIG. 7 is a conceptual diagram illustrating an example parallel sorting network performed at neural processor circuit, according to one embodiment.

The figures depict and the detail description describes various non-limiting embodiments for purposes of illustration only.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, the described embodiments may be practiced without these specific details. In other instances, well-known methods, procedures, components, circuits, and networks have not been described in detail so as not to unnecessarily obscure aspects of the embodiments.

Embodiments of the present disclosure relate to a neural engine circuit of a neural network processor circuit that performs a key-based, lexicographical, parallel sorting operation. The neural engine circuit includes operation circuits and an accumulator circuit coupled to the outputs of the operation circuits. Each of the operation circuits operates in parallel and compares corresponding fields of two records to generate a comparison result, which may then be masked according to a key mask. The key mask indicates which fields of a record are key fields used to sort the compared records. The masked comparison result can then be input to a priority encoder that can swap addresses of the records according to an order in which the records are to be sorted (e.g., highest to lowest values at key fields).

### Exemplary Electronic Device

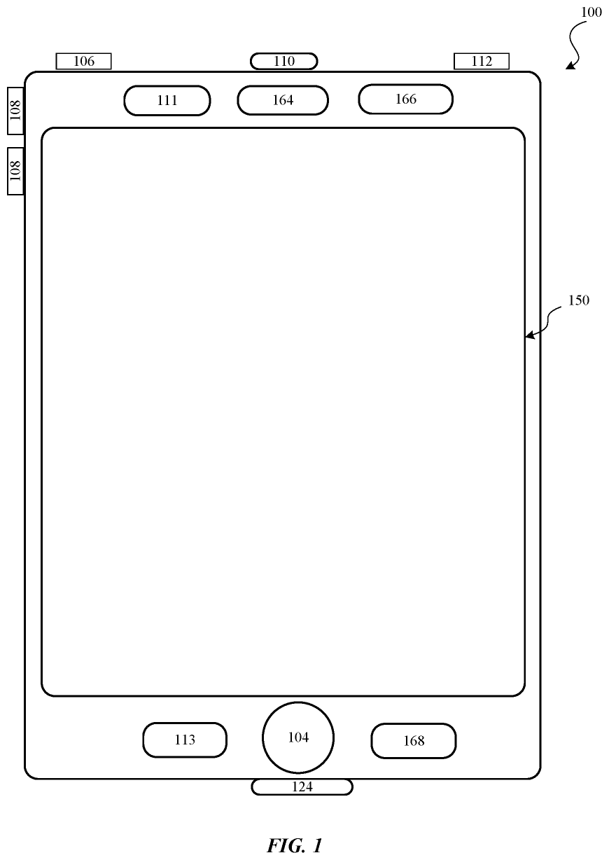

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, Calif. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to one embodiment. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 includes various components including, but not limited to, a memory (which may include one or more computer readable storage mediums), a memory controller, one or more central processing units (CPUs), a peripherals interface, an RF circuitry, an audio circuitry, speaker 111, microphone 113, input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1 such as an ambient light sensor, a dot projector and a flood illuminator that is to support facial recognition.

Device 100 is only one example of an electronic device, and device 100 may have more or fewer components than listed above, some of which may be combined into a component or have a different configuration or arrangement. The various components of device 100 listed above are embodied in hardware, software, firmware or a combination thereof, including one or more signal processing and/or application-specific integrated circuits (ASICs).

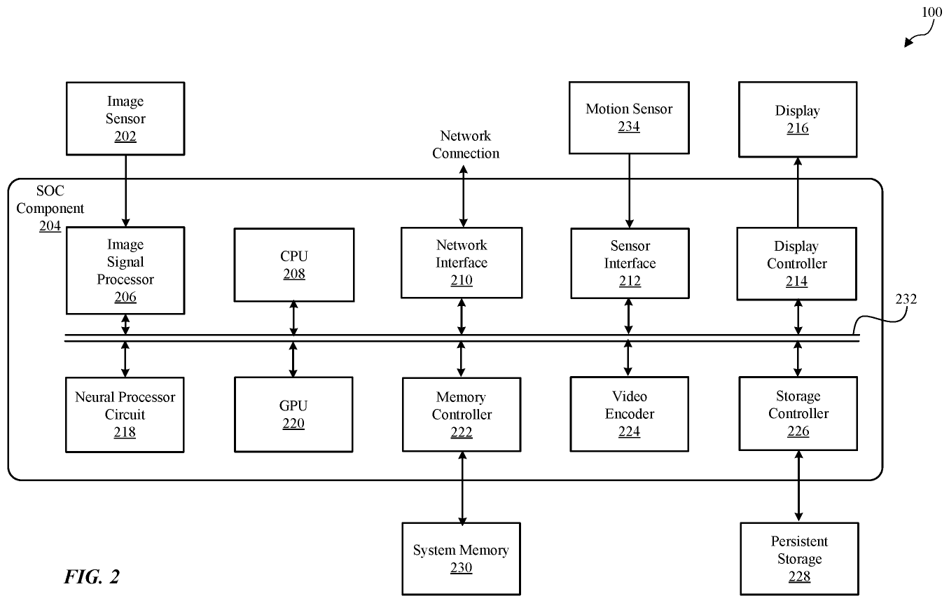

FIG. 2 is a block diagram illustrating components in device 100, according to one embodiment. Device 100 may perform various operations including implementing one or more machine learning models. For this and other purposes, device 100 may include, among other components, image sensors 202, a system-on-a chip (SOC) component 204, a system memory 230, a persistent storage (e.g., flash memory) 228, a motion sensor 234, and a display 216. The components as illustrated in FIG. 2 are merely illustrative. For example, device 100 may include other components (such as speaker or microphone) that are not illustrated in FIG. 2. Further, some components (such as motion sensor 234) may be omitted from device 100.

An image sensor 202 is a component for capturing image data and may be embodied, for example, as a complementary metal-oxide-semiconductor (CMOS) active-pixel sensor a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light-emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM) or a combination thereof.

Persistent storage 228 is a component for storing data in a non-volatile manner. Persistent storage 228 retains data even when power is not available. Persistent storage 228 may be embodied as read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) such as convolutional network networks (CNNs), recurrent network networks (RNNs), autoencoders, and long short term memory (LSTM). A machine learning model may be an independent model that works with the neural processor circuit 218 and various software applications or sensors of device 100. A machine learning model may also be part of a software application. The machine learning models may perform various tasks such as facial recognition, image classification, object, concept, and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results in runtime using the models. For example, in one case, device 100 captures facial images of the user and uses the images to continue to improve a machine learning model that is used to lock or unlock the device 100.

SOC component 204 is embodied as one or more integrated circuit (IC) chips and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor unit (GPU) 220, memory controller 222, video encoder 224, storage controller 226, and bus 232 connecting these subcomponents. SOC component 204 may include more or fewer subcomponents than those shown in FIG. 2.

ISP 206 is a circuit that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations such as image translation operations, horizontal and vertical scaling, color space conversion and/or image stabilization transformations.

CPU 208 may be embodied using any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

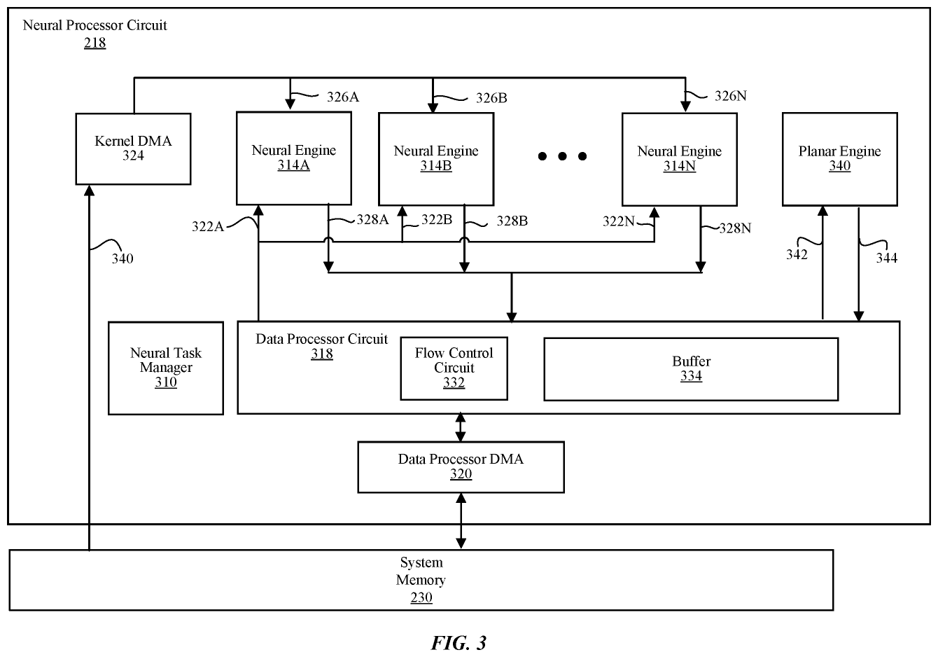

Neural processor circuit 218 is a circuit that performs various machine learning operations based on computation including multiplication, addition, comparison, and accumulation. Such computation may be arranged to perform, for example, various types of tensor multiplications such as tensor product and convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, the image signal processor 206, persistent storage 228, system memory 230 or other sources such as network interface 210 or GPU 220. The output of neural processor circuit 218 may be provided to various components of device 100 such as image signal processor 206, system memory 230 or CPU 208 for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to image signal processor 206) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on neural processor circuit 218, ISP 206, CPU 208 or GPU 220. Such software components may be stored in system memory 230, persistent storage 228 or another device communicating with device 100 via network interface 210.

### Example Neural Processor Circuit

Neural processor circuit 218 is a programmable circuit that performs machine learning operations on the input data of neural processor circuit 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as hidden layers. Each layer may include one or more nodes, which may be fully or partially connected to other nodes in adjacent layers. In forward propagation, the neural network performs computation in the forward direction based on outputs of a preceding layer. The operation of a node may be defined by one or more functions. The functions that define the operation of a node may include various computation operation such as convolution of data with one or more kernels, parallel sorting of data, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tanh), and rectified linear unit functions (ReLU). After a batch of data of training samples passes through a neural network in the forward propagation, the results may be compared to the training labels of the training samples to compute the network's loss function, which represents the performance of the network. In turn, the neural network performs backpropagation by using coordinate descent such as stochastic coordinate descent (SGD) to adjust the coefficients in various functions to improve the value of the loss function.

In training, device 100 may use neural processor circuit 218 to perform all or some of the operations in the forward propagation and backpropagation. Multiple rounds of forward propagation and backpropagation may be performed by neural processor circuit 218, solely or in coordination with other processors such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

For prediction or inference, device 100 may receive one or more input samples. Neural processor circuit 218 may take the input samples to perform forward propagation to determine one or more results. The input samples may be images, speeches, text files, sensor data, or other data.

Data and functions (e.g., input data, kernels, functions, layers outputs, gradient data) in machine learning may be saved and represented by one or more tensors. Common operations related to training and runtime of a machine learning model may include tensor product, tensor transpose, tensor elementwise operation, convolution, sorting, application of an activation function, automatic differentiation to determine gradient, statistics and aggregation of values in tensors (e.g., average, variance, standard deviation), tensor rank and size manipulation, etc.

While the training and runtime of a neural network is discussed as an example, the neural processor circuit 218 may also be used for the operations of other types of machine learning models, such as a kernel SVM.

Referring to FIG. 3, an example neural processor circuit 218 may include, among other components, neural task manager 310, neural engines 314A through 314N (hereinafter collectively referred as “neural engines 314” and individually also referred to as “neural engine 314”), kernel direct memory access (DMA) 324, data processor circuit 318, data processor DMA 320, and planar engine 340. Neural processor circuit 218 may include fewer or additional components not illustrated in FIG. 3.

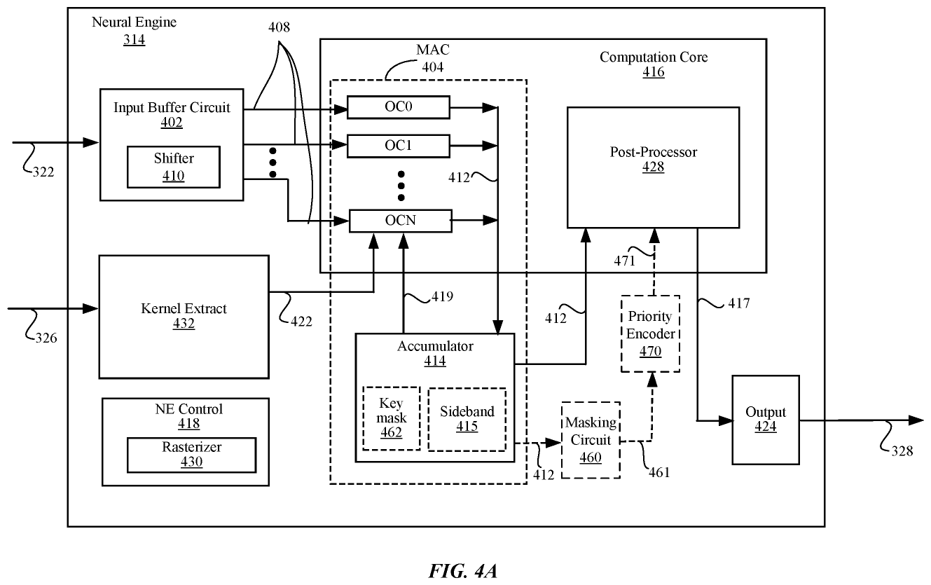

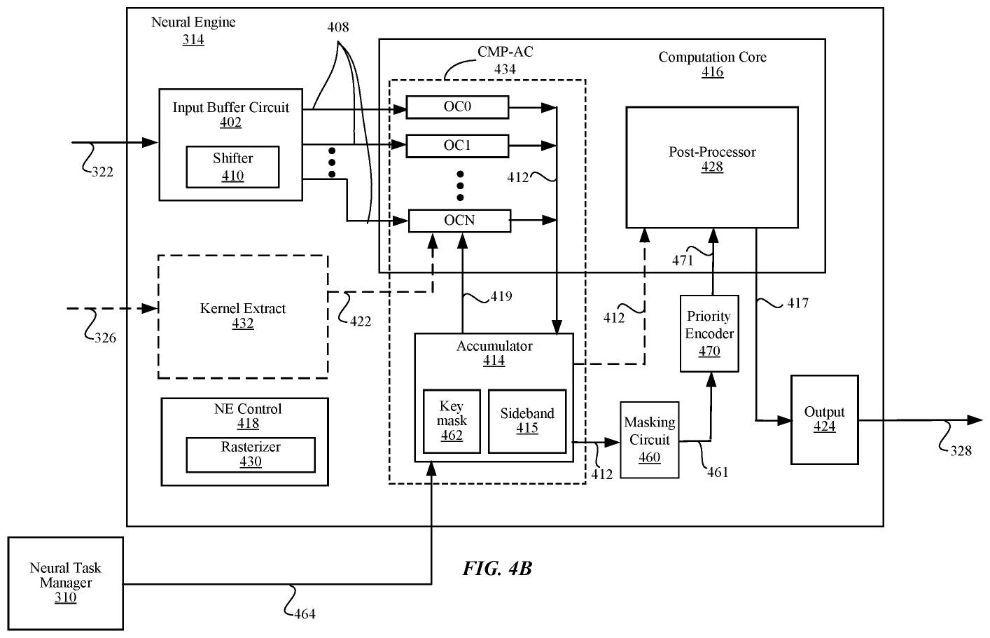

Each of neural engines 314 performs computing operations for machine learning in parallel. Depending on the load of operation, the entire set of neural engines 314 may be operating or only a subset of the neural engines 314 may be operating while the remaining neural engines 314 are placed in a power-saving mode to conserve power. Each of neural engines 314 includes components for storing one or more kernels, for performing multiply-accumulate operations, for performing parallel sorting operations, and for post-processing to generate an output data 328, as described below in detail with reference to FIGS. 4A and 4B. Neural engines 314 may specialize in performing computation heavy operations such as convolution operations and tensor product operations. Convolution operations may include different kinds of convolutions, such as cross-channel convolutions (a convolution that accumulates values from different channels), channel-wise convolutions, and transposed convolutions.

Planar engine 340 may specialize in performing simpler computing operations whose speed may primarily depend on the input and output (I/O) speed of the data transmission instead of the computation speed within planar engine 340. Those computing operations may be referred to as I/O bound computations. In contrast, neural engines 314 may focus on complex computation whose speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In one embodiment, input data may be a tensor whose rank is larger than three (e.g., having three or more dimensions). A set of dimensions (two or more) in the tensor may be referred to as a plane while another dimension may be referred to as a channel. Neural engines 314 may convolve data of a plane in the tensor with a kernel and accumulate results of the convolution of different planes across different channels. On the other hand, planar engine 340 may specialize in operations within the plane.

The circuitry of planar engine 340 may be programmed for operation in one of multiple modes, including a pooling mode, an elementwise mode, and a reduction mode. In the pooling mode, planar engine 340 reduce a spatial size of input data. In the elementwise mode, planar engine 340 generates an output that is derived from elementwise operations of one or more inputs. In the reduction mode, planar engine 340 reduces the rank of a tensor. For example, a rank 5 tensor may be reduced to a rank 2 tensor, or a rank 3 tensor may be reduced to a rank 0 tensor (e.g., a scalar).

Neural task manager 310 manages the overall operation of neural processor circuit 218. Neural task manager 310 may receive a task list from a compiler executed by CPU 208, store tasks in its task queues, choose a task to perform, and send task commands to other components of the neural processor circuit 218 for performing the chosen task. Data may be associated with a task command that indicates the types of operations to be performed on the data. Data of the neural processor circuit 218 includes input data that is transmitted from another source such as system memory 230, and data generated by the neural processor circuit 218 in a previous operation cycle. Each dataset may be associated with a task command that specifies the type of operations to be performed on the data. Neural task manager 310 may also perform switching of tasks on detection of events such as receiving instructions from CPU 208. In one or more embodiments, neural task manager 310 sends rasterizer information to the components of neural processor circuit 218 to enable each of the components to track, retrieve or process appropriate segments of the input data and kernel data. For example, neural task manager 310 may include registers that stores the information regarding the size and rank of a dataset for processing by the neural processor circuit 218. Although neural task manager 310 is illustrated in FIG. 3 as part of neural processor circuit 218, neural task manager 310 may be a component outside the neural processor circuit 218.

Kernel DMA 324 is a read circuit that fetches kernel data from a source (e.g., system memory 230) and sends kernel data 326A through 326N to each of the neural engines 314. Kernel data represents information from which kernel elements can be extracted. In one embodiment, the kernel data may be in a compressed format which is decompressed at each of neural engines 314. Although kernel data provided to each of neural engines 314 may be the same in some instances, the kernel data provided to each of neural engines 314 is different in most instances. In one embodiment, the direct memory access nature of kernel DMA 324 may allow kernel DMA 324 to fetch and write data directly from the source without the involvement of CPU 208.

Data processor circuit 318 manages data traffic and task performance of neural processor circuit 218. Data processor circuit 318 may include a flow control circuit 332 and a buffer 334. Buffer 334 is temporary storage for storing data associated with operations of neural processor circuit 218 and planar engine 340, such as input data that is transmitted from system memory 230 (e.g., data from a machine learning model) and other data that is generated within neural processor circuit 218 or planar engine 340. The data stored in data processor circuit 318 may include different subsets that are sent to various downstream components, such as neural engines 314 and planar engine 340.

In one embodiment, buffer 334 is embodied as a non-transitory memory that can be accessed by neural engines 314 and planar engine 340. Buffer 334 may store input data 322A through 322N for feeding to corresponding neural engines 314A through 314N or planar engine 340, as well as output data 328A through 328N from each of neural engines 314A through 314N or planar engine 340 for feeding back into one or more neural engines 314 or planar engine 340, or sending to a target circuit (e.g., system memory 230). Buffer 334 may also store input data 342 and output data 344 of planar engine 340 and allow the exchange of data between neural engine 314 and planar engine 340. For example, one or more output data 328A through 328N of neural engines 314 are used as the input 342 to planar engine 340. Likewise, the output 344 of planar engine 340 may be used as the input data 322A through 322N of neural engines 314. The inputs of neural engines 314 or planar engine 340 may be any data stored in buffer 334. For example, in various operating cycles, the source datasets from which one of the engines fetches as inputs may be different. The input of an engine may be an output of the same engine in previous cycles, outputs of different engines, or any other suitable source datasets stored in buffer 334. Also, a dataset in buffer 334 may be divided and sent to different engines for different operations in the next operating cycle. Two datasets in buffer 334 may also be joined for the next operation.

Flow control circuit 332 of data processor circuit 318 may control the exchange of data between neural engines 314 and planar engine 340. The operations of data processor circuit 318 and other components of neural processor circuit 218 are coordinated so that the input data and intermediate data stored in data processor circuit 318 may be reused across multiple operations at neural engines 314 and planar engine 340, thereby reducing data transfer to and from system memory 230. Flow control circuit 332 may perform one or more of the following operations: (i) monitor the size and rank of data (e.g. data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., the data processor circuit 318 may operate in a broadcast mode where the same data is fed to multiple input channels of neural engines 314 so that multiple or all neural engines 314 receive the same data or in a unicast mode where different neural engines 314 receives different data), and (iv) transmit a configuration command to the planar engine 340 to direct planar engine 340 to program itself for operating in one of multiple operation modes.

The data of neural processor circuit 218 stored in buffer 334 may be part of, among others, image data, histogram of oriented gradients (HOG) data, audio data, metadata, output data 328 of a previous cycle of a neural engine 314, and other processed data received from other components of the SOC component 204.

Data processor DMA 320 includes a read circuit that receives a segment of the input data from a source (e.g., system memory 230) for storing in buffer 334, and a write circuit that forwards data from buffer 334 to a target component (e.g., system memory). In one embodiment, the direct memory access nature of data processor DMA 320 may allow data processor DMA 320 to fetch and write data directly from a source (e.g., system memory 230) without the involvement of CPU 208. Buffer 334 may be a direct memory access buffer that stores data of a machine learning model of device 100 without involvement of CPU 208.

### Example Neural Engine Architecture

FIG. 4A is a block diagram of neural engine 314, according to one embodiment. Specifically, FIG. 4A illustrates neural engine 314 perform operations including operations to facilitate machine learning such as convolution, tensor product, and other operations that may involve heavy computation in the first mode. For this purpose, neural engine 314 receives input data 322, performs multiply-accumulate operations (e.g., convolution operations) on input data 322 based on stored kernel data, performs further post-processing operations on the result of the multiply-accumulate operations, and generates output data 328. Input data 322 and/or output data 328 of neural engine 314 may be of a single channel or span across multiple channels.

Neural engine 314 may include, among other components, input buffer circuit 402, computation core 416, neural engine (NE) control 418, kernel extract circuit 432, accumulator 414, masking circuit 460, priority encoder 470, and output circuit 424. Neural engine 314 may include fewer components than what is illustrated in FIG. 4A or include further components not illustrated in FIG. 4A.

In the first mode, input buffer circuit 402 stores a subset of the data of neural processor circuit 218 as the subset of data is received from a source. The source may be data processor circuit 318, planar engine 340, or another suitable component. Input buffer circuit 402 sends an appropriate segment 408 of data for a current task or process loop to computation core 416 for processing. Input buffer circuit 402 may include a shifter 410 that shifts read locations of input buffer circuit 402 to change segment 408 of data sent to computation core 416. By changing segments of input data 322 provided to computation core 416 via shifting, neural engine 314 can perform multiply-accumulate for different segments of input data 322 based on a fewer number of read operations. In one or more embodiments, the data of neural processor circuit 218 includes data of different convolution groups and/or input channels.

In the first mode, kernel extract circuit 432 receives kernel data 326 from kernel DMA 324 and extracts kernel coefficients 422. In one embodiment, kernel extract circuit 432 references a lookup table (LUT) and uses a mask to reconstruct a kernel from compressed kernel data 326 based on the LUT. The mask indicates locations in the reconstructed kernel to be padded with zero and remaining locations to be filled with numbers. Kernel coefficients 422 of the reconstructed kernel are sent to computation core 416 to populate registers in operation circuits of computation core 416. In other embodiments, kernel extract circuit 432 receives kernel data 326 in an uncompressed format and the kernel coefficients 422 are determined without referencing a LUT or using a mask.

In the first mode, computation core 416 performs computation operations. For this purpose, computation core 416 may include operation circuits OC0 through OCN and a post-processor 428. Each of operation circuits OC0 through OCN may store an input value in the segment 408 of the input data and a corresponding kernel coefficient in kernel coefficients 422. The input value and the corresponding kernel coefficient are multiplied in each of operation circuits OC0 through OCN to generate a processed value 412.

In the first mode, accumulator 414 receives and stores processed values 412 as a first result from operation circuits. The processed values stored in accumulator 414 may be sent back as feedback information 419 for further multiply and add operations at operation circuits or sent to post-processor 428 for post-processing. In the first mode, accumulator 414 in combination with operation circuits form a multiply-accumulator (MAC) 404. In one or more embodiments, accumulator 414 may have sections where each section sends data to different components of neural engine 314. For example, during a processing cycle, data stored in a first section of accumulator 414 is sent to the MAC 404 while data stored in a second section of accumulator 414 is sent to post-processor 428.

In the first mode, post-processor 428 performs further processing of values 412 received from accumulator 414. Post-processor 428 may perform operations including, but not limited to, applying linear functions (e.g., Rectified Linear Unit (ReLU)), normalized cross-correlation (NCC), merging the results of performing neural operations on 8-bit data into 16-bit data, and local response normalization (LRN). The result of such operations is output from post-processor 428 as processed values 417 to output circuit 424. In some embodiments, the processing at the post-processor 428 is bypassed. For example, the data in accumulator 414 may be sent directly to output circuit 424 for access by other components of neural processor circuit 218. In the first mode, the data in accumulator 414 may also bypass masking circuit 460 and priority encoder 470, which can be used during the second mode of operation.

NE control 418 controls operations of other components of neural engine 314 based on the operation modes and parameters of neural processor circuit 218. Depending on different modes of operation (e.g., first mode or second mode), different convolution modes of operation (e.g., group convolution mode or non-group convolution mode), or parameters (e.g., the number of input channels and the number of output channels), neural engine 314 may operate on different input data in different sequences, return different values from accumulator 414 to operation circuits, and perform different types of post-processing operations at post-processor 428. To configure components of neural engine 314 to operate in a desired manner, the NE control 418 sends task commands that may be included in information 419 to components of neural engine 314. NE control 418 may include a rasterizer 430 that tracks the current task or process loop being processed at neural engine 314.

In the first mode, rasterizer 430 may perform the operations associated with dividing the input data into smaller units (segments) and regulating the processing of the smaller units through the operation circuits and accumulator 414. Rasterizer 430 keeps track of sizes and ranks of segments of the input/output data (e.g., groups, work units, input channels, output channels) and instructs the components of a neural processor circuit 218 for proper handling of the segments of the input data. For example, rasterizer 430 operates shifters 410 in input buffer circuits 402 to forward correct segments 408 of input data 322 to MAC 404 and send the finished output data 328 to data buffer 334. Other components of neural processor circuit 218 (e.g., kernel DMA 324, buffer DMA 320, data buffer 334, planar engine 340) may also have their corresponding rasterizers to monitor the division of input data and the parallel computation of various segments of input data 322 in different components.

In the first mode, output circuit 424 receives processed values 417 from post-processor 428 and interfaces with data processor circuit 318 to store processed values 417 in data processor circuit 318. For this purpose, output circuit 424 may send out as output data 328 in a sequence or a format that is different from the sequence or format in which the processed values 417 are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include, but are not limited to, mapping between input data elements and kernel elements, the number of input channels, the number of output channels, performing of output strides, and enabling/selection of post-processing operations at post-processor 428.

FIG. 4B is a block diagram of neural engine 314 illustrating operations in a second mode, according to one embodiment. In the second mode, neural engine 314 performs parallel sorting operations (e.g., bitonic sorting, top-k bitonic sorting, counting sort, radix sort, Batcher odd-even merge sort, pairwise sort, etc.). For this purpose, neural engine 314 receives input data 322 and performs a portion of a parallel sorting operation (e.g., a comparison operation) on input data 322. The parallel sorting operation includes a key-based comparison and swapping of input data 322. Neural engine 314 performs further post-processing operations on the result of the parallel sorting operation and generates output data 328.

In the second mode, neural engine 314 may perform key-based, lexicographical parallel sorting. Input buffer circuit 402 stores a subset of the data of neural processor circuit 218 as the subset of data is received from a source (e.g., data processor circuit 318, planar engine 340, or another suitable component). Input buffer circuit 402 sends an appropriate segment 408 of data for a current task or process loop to computation core 416 for processing. Processed values 412 are stored in accumulator 414 and provided to masking circuit 460 to mask non-key fields. Masking circuit 460 sends masked values 461 to priority encoder 470 to compare key fields of masked values 461. Priority encoder 470 provides processed values 412 to post-processor 428 in a sequence that is ordered according to a key-based, lexicographical parallel sorting. In one example of determining a sequence for providing processed values 412, priority encoder 470 swaps addresses at which processed values 412 are stored in accumulator 414 based on a comparison of key-fields of processed values 412. In this way, priority encoder 470 can re-address processed values 412 in an order of highest to lowest masked, processed values.

The second mode of operation may be performed in different sub-modes: resident and non-resident modes. In a resident mode, data for the comparison operation is stored in software-managed memory closer to neural engine 314 (e.g., stored at memory of data processor circuit 318). In a non-resident mode, data may be stored external to neural processor circuit 218 (e.g., stored in system memory 230). In some embodiments, more data can be stored external to the neural processor circuit 218 than closer to the neural engine 314. The comparison operation may be run in a non-resident mode if an amount of data to be compared exceeds a threshold amount. An example threshold may be 2\hat{ }16 or 65,536 records of data, where a “record” is a structure of data described in more detail below. The neural processor circuit 218 may store records in system memory 230 and load them into the data processing circuit 318 for sorting by the neural engine 314. The parallel sorting (e.g., bitonic sorting) performed by neural engines 314 may enable the large amount of records to be sorted by neural processor circuit 218 in an efficient manner.

In a first example of sending data to computation core 416 for processing, segment 408 of data may include a single vector or multiple vectors. Input buffer circuit 402 may include a shifter 410 that shifts read locations of input buffer circuit 402 to change segment 408 of data sent to computation core 416. For example, at a first time, input buffer circuit 402 may send a first vector to computation core 416, and at a second time, input buffer circuit 402 may send a second vector to computation core 416. By changing segments of input data 322 provided to computation core 416 via shifting, neural engine 314 can perform various portions of a parallel sorting operation for different segments of input data 322 based on a fewer number of read operations to data processor circuit 318 or system memory 230.

In a second example of sending data to computation core 416 for processing, segment 408 may include multiple records of data. A record may include one or more fields. The fields may be binary, alphanumeric, or any suitable format of representing a data value. For example, a record may include up to eight 16-bit fields. One or more of the fields may be used as keys for the neural engine 314 to compare the records at the key fields. The fields that are not keys, which may be referred to herein as “non-key fields,” may not be used for sorting by neural engine 314. For example, neural engine 314 does not compare two corresponding non-key fields of two records.

In the second mode, kernel extract circuit 432 is disabled by the NE control 418 while operation circuits OC0 through OCN perform sorting operations on the segment 408 of the input data. Specifically, each of operations circuits OC0 through OCN compares an input value to a previous input value to generate a processed value 412. An operation circuit of the operation circuits OC0 through OCN may compare each field of a first record, which may have been previously stored, to a corresponding field of a second record, which may be currently input into the operational circuits. This comparison result may include values indicating that the corresponding fields of the first and second record are equal or not equal (e.g., greater than or less than). In one embodiment of record comparison, one record (e.g., having eight fields, with each field interpreted as a 16-bit floating-point number) is subtracted from another record. The result of the subtraction, which is the comparison result, may be less than, equal to, or greater than zero. The operation circuit may encode the comparison result with a sign bit and a zero bit. If the comparison result is less than zero, the sign bit may be set while the zero bit is not set, or clear. If the comparison result is equal to zero, the sign bit is clear and the zero bit is set. If the comparison result is greater than zero, the sign bit is clear and the zero bit is also clear. The result of the comparison may be stored in accumulator 414. For example, the values of the zero and sign bits may be stored in sideband 415. The comparison of corresponding fields of two records may be a lexicographical comparison.

In some embodiments, value 471 may be a maximum value or a minimum value. In addition or alternative to a comparison and swapping operation, the second mode of operation may include a minimum or maximum determination. Instead of swapping the address of records, the neural engines may output a minimum or maximum record of a pair of two records. Further yet, the second mode of operation may include a Top-K determination. The Top-K determination may use bitonic sorting that determines the top K of N records (e.g., K maximum or K minimum records). In one example of Top-K, the neural engines may sort the records, swapping them to be ordered from minimum to maximum or maximum to minimum, and output the top K results of the sorted records.

In the second mode, accumulator 414 receives and stores a result of comparison operation as the second result from operation circuits. The processed values 412 stored in accumulator 414 may be sent back as feedback information 419 for further comparison operations (e.g., for performing a subsequent portion of the parallel sorting operation) at operation circuits OC0 through OCN or sent to post-processor 428 for post-processing. In the second mode, accumulator 414 in combination with operation circuits OC0 through OCN form a comparator-accumulator (CMP-AC) 434. In one or more embodiments, accumulator 414 may have sections where each section sends data to different components of neural engine 314. For example, during a processing cycle, data stored in a first section of accumulator 414 is sent to CMP-AC 434 while data stored in a second section of accumulator 414 is sent to post-processor 428. The second section may be sideband 415. The data stored in sideband 415 may be the comparison result of comparing at least two records with one another. One or more comparison results 412 may be transmitted to masking circuit 460 from sideband 415, followed by priority encoder 470 for additional processing before being received at post-processor 428.

Masking circuit 460 masks an output of accumulator 414. For example, masking circuit 460 receives the comparison result of records stored in accumulator 414. The comparison results may indicate, for corresponding fields of a pair of records, if one value is greater than, equal to, or less than the other value. To mask the comparison result, masking circuit 460 receives a key mask (e.g., from a key mask register of accumulator 414) and for each non-key index, as indicated by the key mask, sets the value of the comparison to a modified value (e.g., a predetermined alphanumeric value) indicating that the two fields are equal. By using a value that indicates two fields are equal, the fields are not considered in a comparison and thus, are masked. In another example, masking circuit 460 may use the key mask to encode the comparison result with a zero bit and sign bit that indicate that the two fields are equal by setting the zero bit and clearing the sign bit.

A key mask may indicate which indices of a record are key fields and which are non-key fields. The key mask may be stored in key mask register 462 at accumulator 414. The key mask may be a binary value (e.g., “10010101”). For example, indices at which a key mask is ‘1’ indicate keys and indices at which the key mask is ‘0’ indicate non-keys. Key and non-key fields may be user-specified. In some embodiments, a key mask may be provided by a neural task manager. For example, key mask 464 is provided by neural task manager 310. Although key mask 464 is depicted in FIG. 4B as being provided to accumulator 414 for storage, neural task manager 310 may provide key mask 464 to masking circuit 460 for storage and masking.

Masking circuit 460 transmits masked comparison result 461 of a pair of records to priority encoder 470. Masking circuit 460 may receive multiple comparison results 412 for masking and provide corresponding masked comparison results 461 to priority encoder 470. Each comparison result 461 may include a predicate value (e.g., a predicate bit) that can be used to swap or readdress the records that were compared to generate the comparison result. The value of the predicate bit may be set by accumulator 414 when the comparison result is stored at sideband 415.

Priority encoder 470 is a circuit that swaps the order of two records. In one example, priority encoder 470 can readdress the two records upon determining that the records are not equivalent at key fields specified by the key mask. Priority encoder 470 may use a predicate bit of a comparison result to readdress compared records. Priority encoder 470 receives masked comparison results 461 from masking circuit 460 and traverses each of masked comparison results 461 to determine an order of masked comparison results 461. In one example, priority encoder determines an order of masked comparison results 461 from largest to smallest by traversing each masked comparison result and determining an index of the highest non-zero value in the comparison result. The highest non-zero value may also be referred to as a “first non-zero value.” For example, when traversing the comparison result from left to right, this index may be the left-most non-zero value. Because masking circuit 460, during masking operations, may have set non-key index values to the same modified value (e.g., the modified value is ‘0’), priority encoder 470 traverses key indices to determine the highest unmodified (e.g., non-zero) value of each comparison result.

Priority encoder 470 may determine a sorted sequence of the records using the highest non-zero values of each comparison result. For example, priority encoder 470 orders comparison results according to decreasing order of the highest non-zero index value (e.g., {0,1,0,1} is earlier in a sequence traversed left to right than {0,0,1,0} because of the decreasing order and because the ‘1’ in the second-to-left field of {0,1,0,1} is greater than the ‘0’ in the second-to-left field of {0,0,1,0}). Priority encoder 470 can use the sorted comparison results and predicate bits to readdress the records. Priority encoder 470 may determine a sequence in which the records stored in accumulator 414 are provided to post-processor 428 based on the sorted, traversed comparison results. For example, priority encoder 470 may first transmit a record associated with the comparison result having the left-most non-zero value in a key field to post-processor 428. The records transmitted in a sorted sequence is depicted in FIG. 4B as value 471 from priority encoder 470 to post-processor 428. Operation circuits and priority encoder 470 may perform lexicographical comparisons, and the ordered sequence of records provided to post-processor 428 may be both key-based and lexicographically sorted.

In one example of priority encoder 470 determining a lexicographical comparison of two records, a first record having four fields is {1, 42, 71, −1} and a second record having four fields is {1, 7, 71, 61}. Operation circuits compare the two records to determine a comparison result for each of the fields that indicate that the fields of the first record are, from left to right, equal to, greater than, equal to, and less than the fields of the second record. Priority encoder 470 uses this comparison result to determine that the first record is lexicographically greater than the second record because the highest (e.g., left-most) comparison result that was not two fields being equal to each other was that the first record is greater than the second record. The lexicographic comparison result from priority encoder 470 is used to re-order the records that are output from accumulator 414 to be input to post-processor 428.

In the second mode, post-processor 428, NE control 418 and output circuit 424 may perform substantially the same operations as in the first mode described in FIG. 4A. Rasterizer 430, in the second mode, also performs operations similar to what is performed during the first mode except that it manages and tracks dividing of the input data into smaller units (segments) for sorting operations through CMP-AC 434 and accumulator 414.

Although masking circuit 460 and priority encoder 470 are described above with reference to FIGS. 4A and 4B as being components separate from post-processor 428, one or more of these circuits may be integrated with post-processor 428. Further, these two circuits may be combined into a single circuit.

### Example Operation Circuit and Accumulator Circuit Diagram

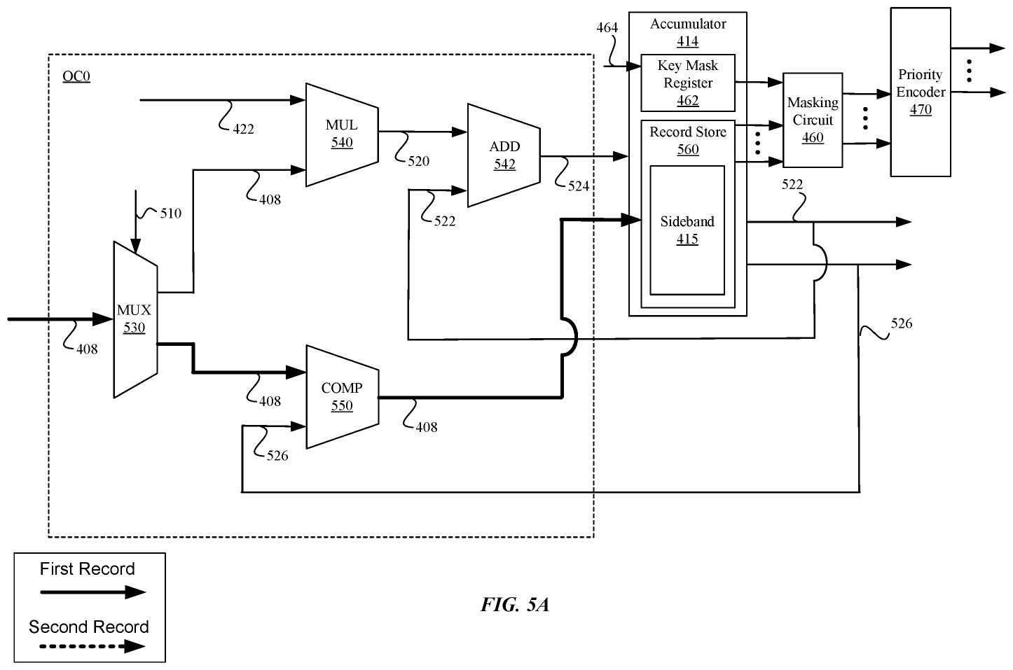

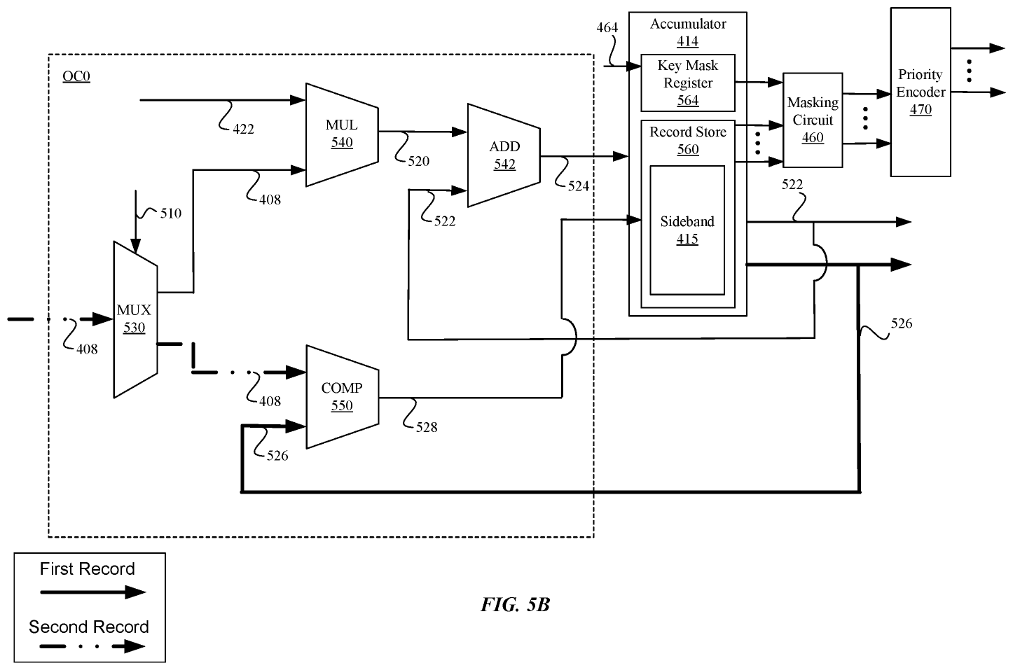

FIGS. 5A and 5B show a circuit diagram in two operational cycles, according to one embodiment. The circuit diagram includes operation circuit OC0, accumulator circuit 414, masking circuit 460, and priority encoder 470 of a neural engine 314. Operation circuit OC0 and accumulator circuit 414 may be programmed to perform in either the first mode or the second mode. In the first mode, operation circuit OC0 may perform multiply-add operations of a convolution on a segment 408 of data and accumulator circuit 414 may operate to receive and store first results 524 (e.g., processed values 412) of the multiply-add operations. Although only a single operation circuit OC0 is described in FIG. 5, other operation circuits OC1 through OCN may have the same structure and operate in the same manner as operation circuit OC0. An operation cycle may be one or more clock cycles.

In the second mode, operation circuit OC0 may perform at least a portion of a parallel sorting operation to sort the segment 408 of data according to the size. For these purposes, operation circuit OC0 may include, among other components, a multiplexor 530, a multiplier 540, an adder 542, and a comparator circuit 550. Operation circuit OC0 may include fewer components or further components not illustrated in FIG. 5. For example, operation circuit OC0 may not include comparator circuit 550 and adder 542 may be utilized as a subtractor in the second mode. In another example of a differing configuration, the adder and comparator circuit may be one logic unit, where the same logic that computes addition also computes a subtraction for the comparison. Each component in operation circuit OC0 may be embodied as a circuit or a circuit in combination with firmware or software.

During operation, operation circuit OC0 receives a segment 408 of data as input at multiplexor 530. Select line 510 controls output of the multiplexor 530. In the first mode, a control signal sent over select line 510 may instruct multiplexor 530 to output segment 408 of data to multiplier 540. In the second mode, the control signal sent over select line 510 may instruct multiplexor 530 to output segment 408 of data to comparator circuit 550. In some embodiments, the control signal is set by neural task manager 310 and stored in a register of neural engine 314.

In the first mode, multiplier 540 multiplies segment 408 of data with a corresponding kernel coefficient of kernel coefficients 422 that results in product value 520 corresponding to a multiplied value of the kernel coefficient and the data. Multiplier 540 provides product value 520 to adder 542. Accumulator 414 provides stored first result 522 (generated as a result of prior adding operation at adder 542) to adder 542 so that adder 542 adds product value 520 to the stored first result 522. After accumulated value 524 is generated by adder 542, accumulated value 524 is again sent to accumulator 414 as first result 522. Updated first result 522 can then be accumulated with another product value 520 in a next round. The process is repeated until all segment 408 of data and corresponding kernel coefficients 422 are processed. When accumulator 414 does not have a stored first result 522 to provide to adder 542 (e.g., in the first round of processing), adder 542 passes product value 520 to accumulator 414 so that the first product value 520 can be stored as an initial first result 522.

In the second mode, comparator circuit 550 receives segment 408 of data from multiplexor 530. Segment 408 of data is depicted in FIG. 5A as a first record. When the first record is received, it passes comparator circuit 550 and is stored in accumulator 414. In a subsequent operation cycle, as depicted in FIG. 5B, a second data value is received as segment 408 of data and is fed to comparator circuit 550. Furthermore, the first record, which is depicted through data value 526, is retrieved from accumulator 414 and fed to comparator circuit 550. Comparator circuit 550 compares the first and second records to produce a comparison result, which is depicted as data value 528. The comparison result is provided to accumulator 414 for storage (e.g., at sideband 415).

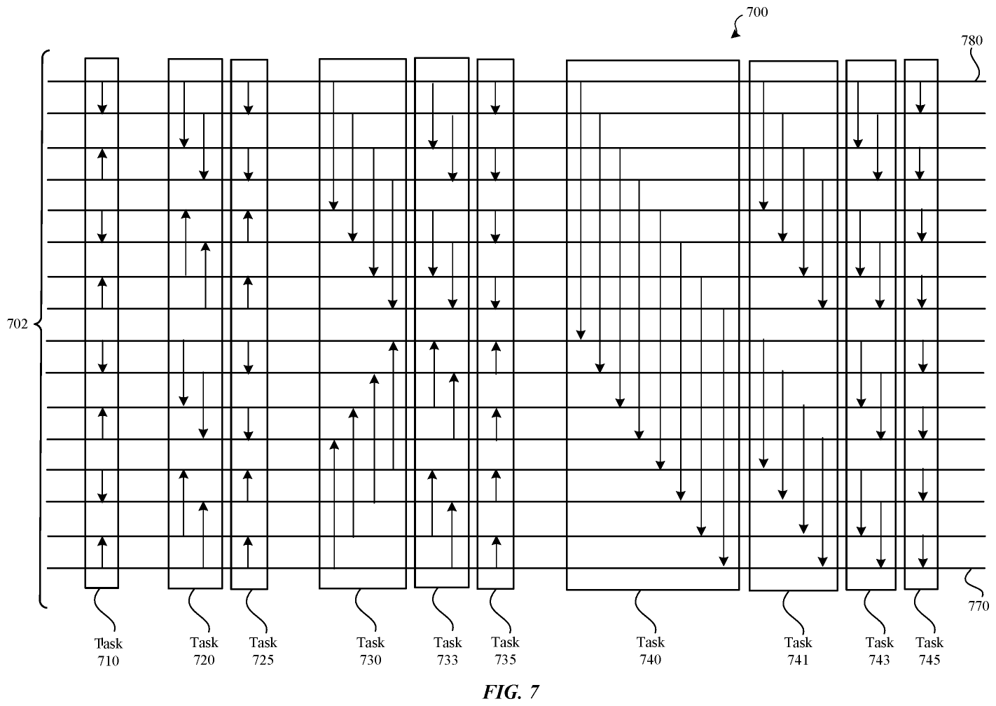

The storage and comparison operations in the operation cycle shown in FIG. 5B may be repeated until a comparison result has been determined for each record (e.g., each record stored in data processor circuit 318). In one example of an order of processing records, the operations shown in FIG. 5A may be performed for receiving an initial record and the operations shown in FIG. 5B may be repeatedly performed for intake of subsequent records until all records are received and compared. The sequence of data values to be compared may be set by rasterizer 430 and may implement a parallel sorting network, as described below in detail with reference to FIG. 7. While operation circuit OC0 is performing its comparison operations in the second mode, one or more of the other operation circuit OC1 through OCN may perform their own comparisons in parallel.

Accumulator 414 may include key mask register 462 that stores key mask 464 (e.g., received from neural task manager 310) and record store 560 that stores records to be compared with other records by comparator circuit 550. Sideband 415 may be a set of registers within as depicted in FIGS. 5A and 5B or outside record store 560. Sideband 415 stores comparison results produced by comparator circuit 550.

Comparison results of pairs of records and a key mask are provided to masking circuit 460. Masking circuit 460 masks the comparison results according to the key and non-key fields specified by the key mask 464. Priority encoder 470 receives masked comparison results from masking circuit 460 and swaps the addresses of the records in record store 560. Priority encoder 470 may then provide the readdressed records in a sorted sequence to a post-processor of the neural processor circuit. Operations of masking circuit 460 and priority encoder 470 are further described in the description of FIG. 4B.

FIGS. 5A and 5B illustrate comparison of two records in a single operation circuit OC0. However, because there are multiple operation circuits in a neural engine, each neural engine may receive and compare multiple records in each operational cycle (e.g., eight records). In some embodiments, of the eight records, four records may be compared to the other four records and swapped accordingly. For example, in a first layer of comparison and swapping performed in the second mode of operation, four records may be compared to another four records in a bitonic sort during one clock cycle and another four records may be compared to another four records in a bitonic sort during a second clock cycle. Thus, two 8-record comparisons may be performed over two clock cycles. During another layer of the comparison and swapping, the bitonic sorting may be performed again with the same records and a different stride and direction of the bitonic sorting.

### Example Process of Operating Neural Engine Circuit

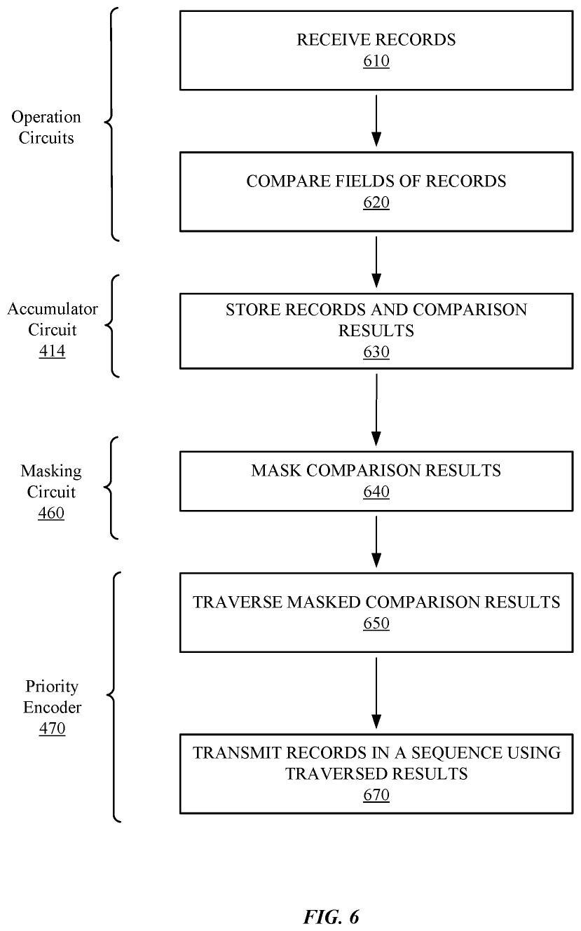

FIG. 6 is a flowchart illustrating a process of key-based sorting using a neural engine circuit, according to one embodiment. Components of a neural processing circuit may perform the process. Embodiments of the process described above with reference to FIG. 6 are merely illustrative. Moreover, sequence of the proves may be modified or omitted.

Operation circuits receive 610 records. The records may be provided by a data processor circuit. In a resident comparison mode, the records are stored at the data processor circuit and in a non-resident comparison mode, the records are stored externally (e.g., in DRAM) and provided to the data processor circuit for temporary storage prior to comparison of the records. In one example embodiment, the received records include a first record and a second record. Each record may include multiple binary values (e.g., eight 16-bit values). In a simplified example of key-based record comparison, a first record is a 4-field record of binary values, {0,1,1,0} and a second record is a 4-field record of {0,0,1,1}.

Operation circuits compare 620 fields of the received records. As described in the description of FIGS. 5A and 5B, comparator 550 may compare two records to produce a comparison result indicating a field-by-field comparison of the two records. Continuing the previous example, a comparison of {0,1,1,0} and {0,0,1,1} may produce a comparison result. In a first example of a comparison result, comparator 550 subtracts {0,0,1,1} from {0,1,1,0} and determines a sign bit and zero bit for each field compared (e.g., clearing a sign bit and setting a zero bit for the leftmost field compared). The sign and zero bits for each field can be used to encode the comparison result. In a second example of a comparison result, comparator 550 outputs {0,2,0,1} as a comparison result, where ‘0’ indicates the values are equivalent, ‘1’ indicates a field of the first record is less than the corresponding field of the second record, and ‘2’ indicates a field of the first record is greater than the corresponding field of the second record.

Accumulator circuit 414 stores 630 records and comparison results. Accumulator circuit 414 may store 630 records at additional times in the process other than depicted in FIG. 6. For example, accumulator 414 may store records after operation circuit receives 610 records and before operation circuits compare 620 the fields of the records. Accumulator circuit 414 may store 630 comparison results in a sideband of accumulator circuit 414. Following the previous, first example, the sign bits (e.g., clear, clear, clear, and set) and zero bits (e.g., set, clear, set, and clear) may be used to encode the comparison result, which is stored in the sideband of accumulator circuit 414. Following the previous, second example, the comparison result of {0,2,0,1} may be stored in sideband 415. The first and second records may be stored in record store 560 at respective addresses.

Masking circuit 460 masks 640 comparison results stored in accumulator circuit 414. Masking circuit 460 masks 640 the comparison results using a key mask. Continuing the previous, first example, a key mask may be {1,0,1,1}, indicating that the first, third, and fourth fields are keys and the second field is a non-key. Because the second field of the keymask is ‘0’ to mask the second field of the comparison result, masking circuit 460 masks the comparison result by setting the zero bit of the second field. The modified zero bits (set, set, set, and clear) now indicate that the first, second, and third fields of the first record are equivalent to the first, second, and third fields of the second record. Continuing the previous, second example, applying an example key mask of {1,0,1,1}to the comparison result of {0,2,0,1} can produce a masked comparison result of {0,0,0,1} because the indices of the comparison result of corresponding to non-key fields are set to ‘0.’ In this way, the key fields are prioritized for comparing records rather than using non-key fields for comparison.

Priority encoder 470 traverses 650 masked comparison results to determine highest, non-zero indices in each masked comparison result and sort comparison results by the determined indices. Using the previous example, priority encoder 470 traverses ‘0001’ and determines the highest non-zero value is at the fourth index. Priority encoder 470 may traverse another masked comparison result (e.g., {0,0,2,1}) to determine that the highest non-zero value is at a different index (e.g., the third index). The masked comparison result of {0,0,2,1} may have a higher priority than {0,0,0,1}, and the order of priority may affect how records are swapped.

Priority encoder 470 transmits 670 records (e.g., to post-processor 428) in a sequence determined using the traversed masked comparison results. Continuing the previous, first example, priority encoder 470 may swap the address of the first record and the second record in accumulator 414 by identifying the first non-zero value of the masked comparison result. The fourth field of the masked zero bits (set, set, set, and clear) is non-zero. Priority encoder 470 may then look at the sign bit of the fourth field, which is set, to determine that the second record is smaller than the first record. Depending on the order in which the records are to be sorted (e.g., increasing or decreasing), priority encoder 470 may swap the addresses of the first and second records after determining that the second record is smaller than the first record. Continuing the previous, second example, priority encoder 470 may swap the address of the first record and the second record in accumulator 414 because the traversed result indicates that the first record is less than the second record. Priority encoder 470 transmits 670 the first and second records to post-processor 428 according to an order of the addresses of the records stored in accumulator 414.

Priority encoder 470 may provide records in descending or ascending address order. Priority encoder 470 may maintain addresses of the first and second records to transmit the records in an appropriate order (e.g., maintaining the addresses if the records were originally addressed in a desired sorting order). Alternatively, priority encoder 470 may swap the addresses of the first and second records to transmit records in an appropriate order. Priority encoder 470 may decide whether or not to swap addresses to transmit the first record or the second record first depending on the desired sorting order (e.g., ascending or descending lexicographical order).

### Example Parallel Sorting Network

FIG. 7 is a conceptual diagram illustrating an example parallel sorting network 700 performed at neural processor circuit 218, according to one embodiment. The parallel sorting network 700 illustrated in FIG. 7 is a bitonic sorting network that receives 16 data values 702 and simultaneously produces a maximum value 770 and a minimum value 780 of input data at the end of the sorting operation.

In the example of FIG. 7, the parallel sorting network 700 is embodied using one or more neural engine circuits 314. Multiple operation circuits (e.g., OC0 through OCN) in the one or more neural engine circuits 314 perform sorting (comparison) operations represented by arrows in FIG. 7. Task 710, task 720, task 725, task 730, task 733, task 735, task 740, task 741, task 743, and task 745 are performed in sequence to accomplish a parallel sorting operation. Each of these tasks may be performed by one or more neural engine circuits 314.

Sorting operations of task 710 may be performed in a single cycle of one neural engine circuit 314 by having 8 of its operation circuits perform the sorting operations in parallel. Alternatively, the same operation may be performed in multiple cycles by using a fewer number of operation circuits in one neural engine circuits 314. If the number of sorting operations is large, operation circuits in two or more neural engine circuits 314 may be operated in parallel.

After task 710 is finished, one or more neural engine circuits 314 are updated to perform task 720 and execute the sorting operations as defined by task 720. After tasks 720, 725, 730, 733, 735, 740, 741, 743 and 745, the indices tagged to the data values indicate the sorted order of the data values. A data value with an index indicating the highest number is output as maximum number 770, and another data value with an index indicating the lowest number is output as minimum number 780.

In alternative embodiments (not shown in FIG. 7), input data may include multiple elements (e.g., 16, 100, 256 elements, etc.). Each element may be an individual data value (e.g., individual elements in a vector), a vector, or multiple vectors that undergo sorting operations by the neural engines 314.

While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure.

What is claimed is:

1. A neural engine circuit, comprising:
a plurality of operation circuits operating in parallel, each of the operation circuits configured to compare a field of a first record of a plurality of records and a corresponding field of a second record of the plurality of records to generate a comparison result on values in the field and the corresponding field; and
an accumulator circuit coupled to the plurality of operation circuits, the accumulator circuit comprising a record store storing the plurality of records and a sideband register storing a plurality of comparison results generated by the plurality of operation circuits.

2. The neural engine circuit of claim 1, wherein the accumulator circuit further comprises a key mask register storing indices indicating a plurality of key fields and a plurality of non-key fields for generating a masked plurality of comparison results.

3. The neural engine circuit of claim 2, further comprising a masking circuit coupled to the accumulator circuit configured to mask the comparison result by setting the values of the plurality of comparison result at the plurality of non-key fields to a modified value indicating the values of the first and second records at the non-key field indices are equal.

4. The neural engine circuit of claim 1, further comprising a priority encoder coupled, via a masking circuit, to the accumulator circuit, the priority encoder configured to:
traverse each of a masked plurality of comparison results at a plurality of key fields indicated by a key mask register; and
transmit, during a read operation, the plurality of records to a post-processor in a sequence determined using the traversed plurality of comparison results.

5. The neural engine circuit of claim 4, wherein the priority encoder is further configured to:
determine a highest non-zero value of each of the masked plurality of comparison results; and
determine the sequence using the highest non-zero values.

6. The neural engine circuit of claim 1, wherein, in a resident mode of operation, the plurality of records are stored at a data processor circuit coupled to the neural engine circuit, and wherein, in a non-resident mode of operation, the plurality of records are stored at a system memory coupled to the neural engine circuit through at least the data processor circuit.

7. The neural engine circuit of claim 1, wherein the comparison result is a lexicographical comparison result.

8. The neural engine circuit of claim 1, wherein the first plurality of records is received during a first operation cycle and the second plurality of records is received during a second operation cycle subsequent to the first operation cycle.

9. The neural engine circuit of claim 1, wherein each of the operation circuits of the plurality of operation circuits comprises a multiplier circuit, an adder circuit, and a comparator circuit, wherein the comparator circuit is configured to determine the comparison result, and wherein the comparator circuit is coupled to the accumulator circuit.

10. A method of operating a neural engine circuit, the method comprising:
comparing, by a plurality of operation circuits operating in parallel, a field of a first record of a plurality of records and a corresponding field of a second record of the plurality of records to generate a comparison result on values in the field and the corresponding field;
storing, by an accumulator circuit coupled to the plurality of operation circuits, the plurality of records; and
storing, by the accumulator circuit, a plurality of comparison results generated by the plurality of operation circuits.

11. The method of claim 10, further comprising storing, at a key mask register of the accumulator circuit, indices indicating a plurality of key fields and a plurality of non-key fields for generating a masked plurality of comparison results.

12. The method of claim 11, further comprising masking, by a masking circuit coupled to the accumulator circuit, the comparison result by setting the values of the plurality of comparison result at the plurality of non-key fields to a modified value indicating the values of the first and second records at the non-key field indices are equal.

13. The method of claim 10, further comprising:
traversing, by a priority encoder coupled via a masking circuit to the accumulator circuit, each of a masked plurality of comparison results at a plurality of key fields indicated by a key mask register; and
transmitting, by the priority encoder during a read operation, the plurality of records to a post-processor in a sequence determined using the traversed plurality of comparison results.

14. The method of claim 13, further comprising:
determining, by the priority encoder, a highest non-zero value of each of the masked plurality of comparison results; and
determining, by the priority encoder, the sequence using the highest non-zero values.

15. The method of claim 10, wherein the field and the corresponding field have the same index in the first record and the second record.

16. The method of claim 10, wherein the comparison result is a lexicographical comparison result.

17. The method of claim 10, wherein the first plurality of records is received during a first operation cycle and the second plurality of records is received during a second operation cycle subsequent to the first operation cycle.

18. The method of claim 10, wherein each of the operation circuits of the plurality of operation circuits comprises a multiplier circuit, an adder circuit, and a comparator circuit, wherein the comparator circuit is configured to determine the comparison result, and wherein the comparator circuit is coupled to the accumulator circuit.

19. An electronic device, comprising:
at least one neural engine circuit, comprising:
a plurality of operation circuits operating in parallel, each of the operation circuits configured to compare a field of a first record of a plurality of records and a corresponding field of a second record of the plurality of records to generate a comparison result on values in the field and the corresponding field; and
an accumulator circuit coupled to the plurality of operation circuits, the accumulator circuit comprising a record store storing the plurality of records and a sideband register storing a plurality of comparison results generated by the plurality of operation circuits.

20. The electronic device of claim 19,
wherein the accumulator circuit further comprises a key mask register storing indices indicating a plurality of key fields and a plurality of non-key fields for generating a masked plurality of comparison results; and
further comprising a masking circuit coupled to the accumulator circuit configured to mask the comparison result by setting the values of the plurality of comparison result at the plurality of non-key fields to a modified value indicating the values of the first and second records at the non-key field indices are equal.
